(19) United States
(12) Patent Application Publication
(10) Pub. No.: US 2018/0170098 A1
(43) Pub. Date: Jun. 21, 2018

(54) Wheel Assembly

(71) Applicant: Solite International Co., Ltd., Changhua City (TW)

(72) Inventor: Yu Chi Chen, Changhua City (TW)

(21) Appl. No.: 15/381,195

(22) Filed: Dec. 16, 2016

(51) Int. Cl. B60B 9/00; B60B 27/02; B60C 7/10; B60B 19/00

(52) U.S. Cl. CPC B60B 9/00; B60B 27/02; B60C 7/10; B60B 5/02; B60B 2360/10; B60B 2360/324; B60B 2360/50; B60B 19/00

(57) ABSTRACT

A wheel assembly includes a wheel axle, an inner wheel, and an outer wheel. The inner wheel is mounted on the wheel axle. The inner wheel is rotatable about the wheel axle. The inner wheel is rotatably retained in the outer wheel. The inner and outer wheels include a gap therebetween, and the outer wheel is rotatable eccentrically about the wheel axle.

### BACKGROUND OF THE INVENTION

### 1. Field of the Invention

The present invention relates to a wheel assembly and, particularly, to a wheel assembly for luggage.

### 2. Description of the Related Art

TW Pat. No. M452663 discloses a caster assembly for luggage including a wheel carrier and a castor wheel mounted on the wheel carrier. The castor wheel includes a wheel frame and a rubber tire mounted onto the wheel frame. The wheel frame is fastened to the wheel carrier by a rivet. The wheel frame is rotatable about the rivet. The caster assembly makes loud noise when rolling over relatively hard and irregular surfaces.

The present invention is, therefore, intended to obviate or at least alleviate the problems encountered in the prior art.

### SUMMARY OF THE INVENTION

According to the present invention, a wheel assembly includes a wheel axle, an inner wheel, and an outer wheel. The inner wheel is mounted on the wheel axle. The inner wheel is rotatable about the wheel axle. The outer wheel includes a receiving space and an inner circumferential periphery defining the receiving space. The inner wheel is rotatably retained in outer wheel. The inner wheel is disposed in the receiving space. The inner and outer wheels include a gap therebetween and the outer wheel is rotatable eccentrically about the wheel axle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a wheel assembly that does not make much noise when rolling over relatively hard and irregular surfaces.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view showing a luggage case with a wheel assembly in accordance with the present invention.

FIG. 2 is an enlarged, perspective view of the wheel assembly of the present invention.

FIG. 3 is an exploded perspective view of the wheel assembly of the present invention.

FIG. 4 is a cross-sectional view of the wheel assembly of the present invention.

FIG. 5 is another cross-sectional view of the wheel assembly of the present invention.

FIGS. 6 through 9 illustrate the wheel assembly of the present invention rolling over a bump in a surface.

### DETAILED DESCRIPTION OF THE INVENTION

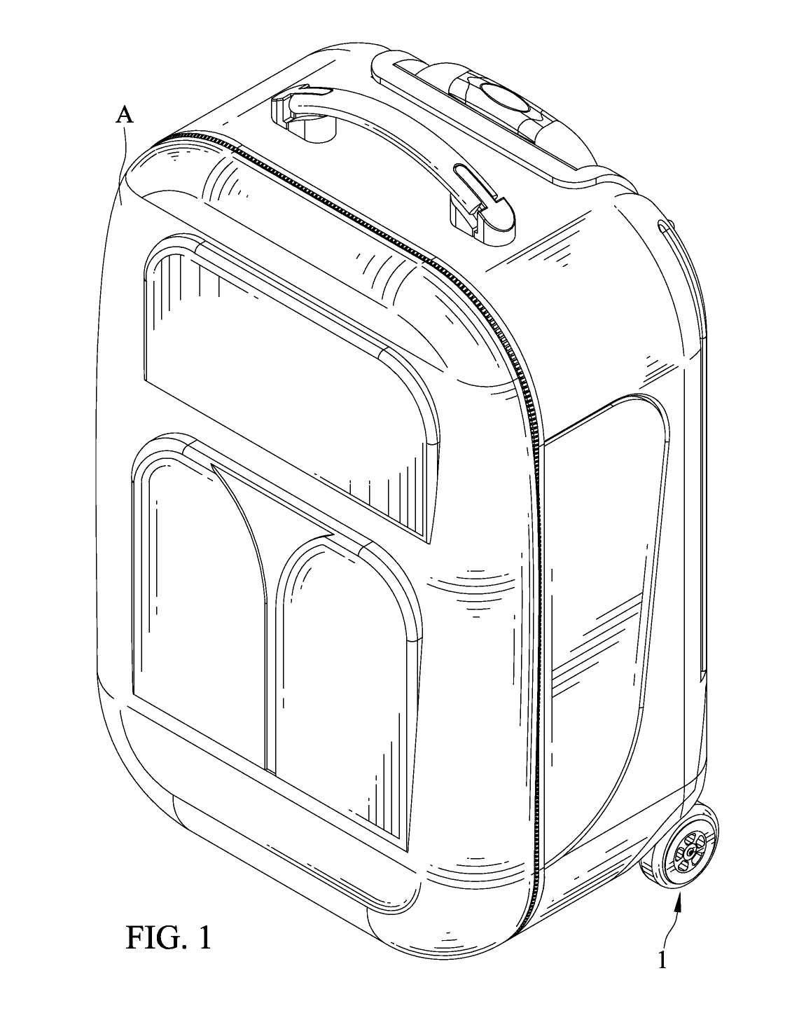

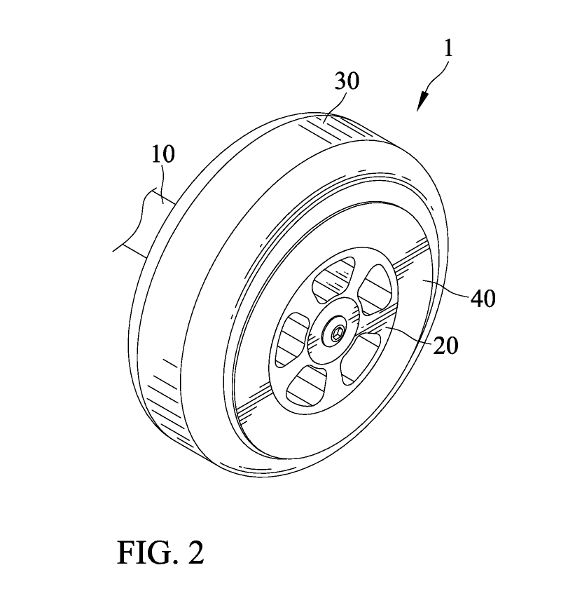

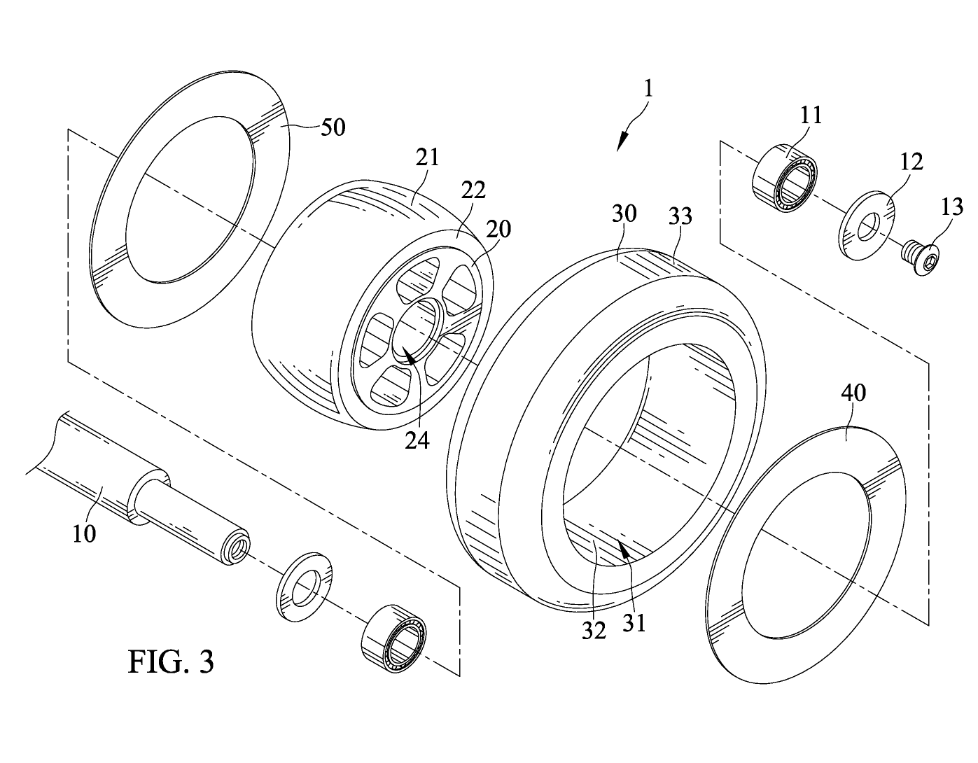

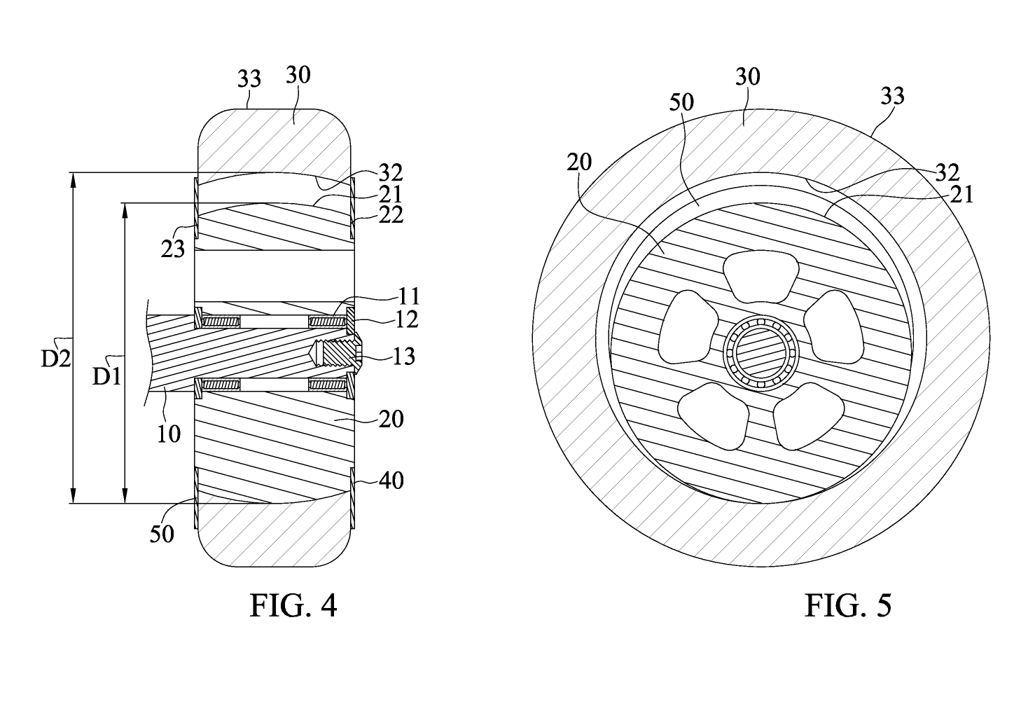

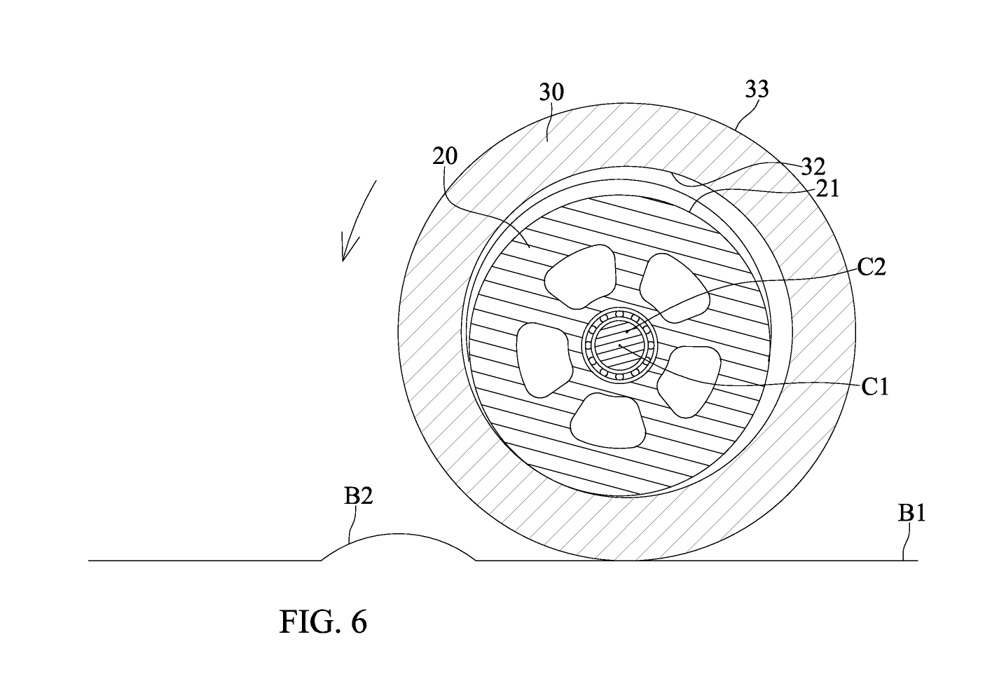

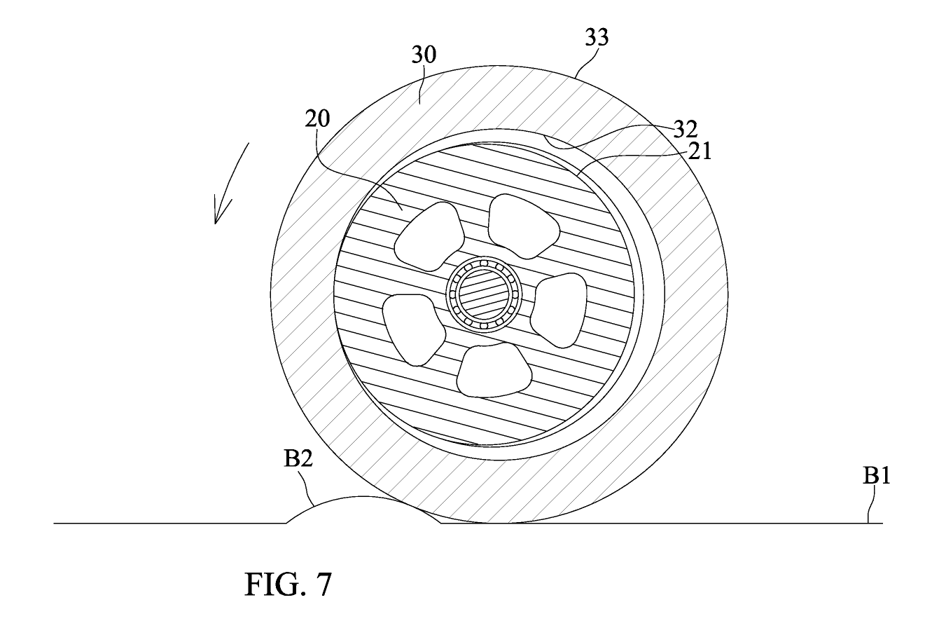

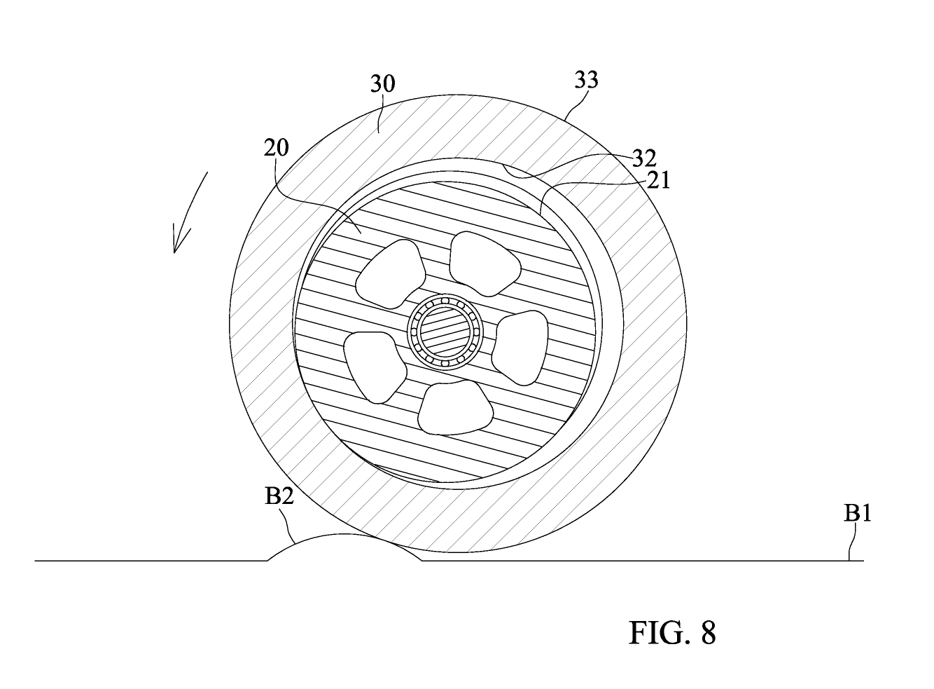

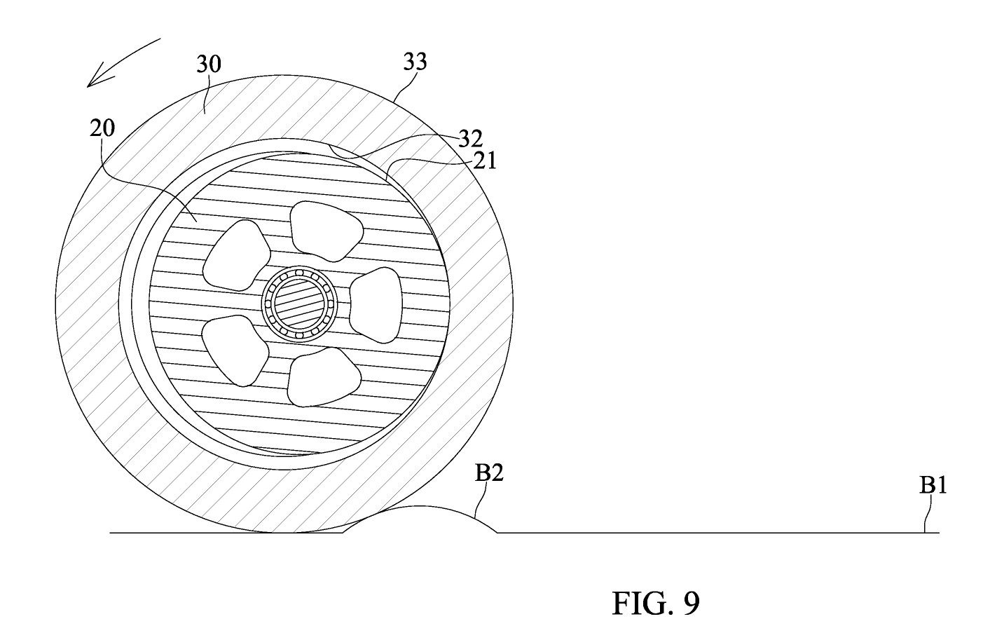

FIGS. 1 through 9 show a wheel assembly 1 in accordance with the present invention. Furthermore, FIG. 1 shows a luggage case A with the wheel assembly 1 of the present invention.

The wheel assembly 1 includes a wheel axle 10.

An inner wheel 20 is mounted on and is rotatable about the wheel axle 10. The inner wheel 20 includes a hole 24 extending therethrough, and the wheel axle 10 extends through the hole 24 to connect with the inner wheel 20. The wheel axle 10 includes at least one bearing 11 mounted thereon. The at least one bearing 11 is disposed in the hole 24. The at least one bearing 11 includes an orifice extending therethrough. The wheel axle 10 extends through the hole 24 and the orifice to connect with the at least one bearing 11 and the inner wheel 20. The at least one bearing 11 is a ball bearing and include an outer circumferentially periphery abutting the periphery of the hole 24. The wheel axle 10 also connects with at least one washer 12. The wheel axle 10 inserts a through hole of the washer 12. Further, a fastener 13 is engaged with an end of the wheel axle 10. The at least one bearing 11 and the at least one washer 12 are retained between a side of the wheel axle 11 and the fastener 13 in a transverse direction.

The center of rotation of the inner wheel 20 defines a first center of rotation C1. The inner wheel 20 is made of high rigidity material. The inner wheel 20 is metallic.

An outer wheel 30 includes a receiving space 31 and an inner circumferential periphery 32 defining the receiving space 31. The receiving space 31 extends through two opposite sides of the outer wheel 30 The center of rotation of the outer wheel 30 defines a second center of rotation C2. The outer wheel 30 is made of a softer material than the inner wheel 20. The outer wheel 30 is made of polyurethane. Thus, the amount of noise generated by the outer wheel 30 is reduced. The outer wheel 30 is made of rubber.

The inner wheel 20 is rotatably retained in outer wheel 30. The inner wheel 20 is disposed in the receiving space 31. The inner and outer wheels 20 and 30 include a gap therebetween and the outer wheel 30 is rotatable eccentrically about the wheel axle 10. The inner and outer wheels 20 and 30 include outer circumferential peripheries 21 and 33 respectively of first and second diametrical sizes D1 and D2. The second diameter size D2 is 1.1-1.2 times of the first diametrical size D1. The inner wheel 20 has two opposite lateral sides. The two lateral sides define a first lateral side 22 and a second lateral side 23. The first and second lateral sides 22 and 23 are disposed oppositely in a direction along the wheel axle 10. The inner wheel 20 includes first and second positioning members 40 and 50 respectively mounted on the two lateral sides 22 and 23. The outer wheel 30 is disposed between and positionally limited in a transverse direction by the first and second positioning members 40 and 50.

When the wheel assembly 1 rolls over a surface B1 and/or a bump B2, the wheel axle 10 rotates, the inner wheel 20 rotates about the wheel axle 10, the outer wheel 30 rotates eccentrically about the wheel axle 10, the inner wheel 20 abuts the inner circumferential periphery 32 of the outer wheel 30, and the first and second centers of rotation C1 and C2 are at different locations. Because the inner wheel 20 can rotate relative to the outer wheel 30, the inner wheel 20 generates a propulsion force to drive the outer wheel 30, and the inner and outer wheel 20 and 30 rotate concurrently. Further, when the wheel assembly 1 hits the bump B2, the moment of inertia of outer wheel 30 decreases, a first fulcrum being the point of the contact of the outer wheel 30 with the bump B2, a second fulcrum being the point of the contact of the inner wheel 20 with the inner circumferential periphery 32 of the outer wheel 30, the inner wheel 20 propels the outer wheel 30 and produce a moment of force about the first fulcrum. Thus, the wheel assembly 1 rolls over the bump B2 successfully and easily.

In view of the forgoing, the inner wheel 20 is rotatable about the wheel axle 10 and is rotatably retained in outer wheel 30, and the outer wheel 30 is rotatable eccentrically about the wheel axle 10. When the wheel assembly 1 rolls over the surface B1 and/or the bump B2, the inner wheel 20 rotates about the wheel axle 10, the outer wheel 30 rotates eccentrically about the wheel axle 10, the inner wheel 20 abuts the inner circumferential periphery of the outer wheel 30, and the first and second centers of rotation C1 and C2 are at different locations. Consequently, the wheel assembly 1 can absorb impact forces and rolls over the surface B1 or the bump B2 quietly. Furthermore, the inner wheel 20 generates a propulsion force which can apply to the outer wheel 30, and a user can roll the wheel assembly 1 over all types of surfaces more effortlessly.

The foregoing is merely illustrative of the principles of this invention and various modifications can be made by those skilled in the art without departing from the scope and spirit of the invention.

1. (canceled)

2. Luggage comprising a case, and at least one wheel assembly mounted to the case, with the at least one wheel assembly comprising:
a wheel axle and an inner wheel mounted on the wheel axle, wherein the inner wheel is rotatable about the wheel axle; and
an outer wheel including a receiving space and an inner circumferential periphery defining the receiving space;
wherein the inner wheel is rotatably retained in the outer wheel, with the inner wheel disposed in the receiving space, wherein the inner and outer wheels include a gap therebetween and the outer wheel is rotatable eccentrically about the wheel axle, wherein the inner and outer wheels include an outer circumferential periphery and an inner circumferential periphery respectively of first and second diametrical sizes, and wherein the second diametrical size is 1.1-1.2 times of the first diametrical size.

3. The luggage as claimed in claim 2, wherein the inner circumferential periphery of the outer wheel is made of a softer material than the inner wheel.

4. The luggage as claimed in claim 3, wherein the inner wheel is made of a high rigidity material, with the outer circumferential periphery of the inner wheel directly abutting the inner circumferential periphery of the outer wheel.

5. The luggage as claimed in claim 4, wherein the inner wheel is metallic.

6. The luggage as claimed in claim 5, wherein the outer wheel is made of polyurethane.

7. The luggage as claimed in claim 5, wherein the outer wheel is made of rubber.

8. The luggage as claimed in claim 2, wherein the inner wheel has two opposite lateral sides, wherein the inner wheel includes first and second positioning members respectively and fixed to mounted on the two lateral sides, and wherein the outer wheel is slideably disposed between and positionally limited in a transverse direction by the first and second positioning members.

9. The luggage as claimed in claim 2, wherein the receiving space extends through two opposite sides of the outer wheel.

10. The luggage as claimed in claim 2, wherein the wheel axle includes at least one bearing mounted thereon, with the inner wheel including a hole extending therethrough, with the at least one bearing disposed in the hole, with the at least one bearing includes an orifice extending therethrough, and with the wheel axle extending through the hole and the orifice to connect with the at least one bearing and the inner wheel.
